(19) United States
(12) Patent Application Publication
(10) Pub. No.: US 2020/0125223 A1
(43) Pub. Date: Apr. 23, 2020

(54) METHOD, DEVICE, APPARATUS, AND SYSTEM FOR DISPLAYING DYNAMIC LIST

(71) Applicant: Alibaba Group Holding Limited, George Town (KY)

(72) Inventor: Xiaozhen FU, Hangzhou (CN)

(73) Assignee: Alibaba Group Holding Limited, George Town (KY)

(21) Appl. No.: 16/721,104

(22) Filed: Dec. 19, 2019

Related U.S. Application Data
(63) Continuation of application No. 16/183,419, filed on Nov. 7, 2018.
Application No. 16/183,419 is a continuation of application No. PCT/CN2017/086052, filed on May 26, 2017.

(30) Foreign Application Priority Data
Jun. 7, 2016 (CN) 201610403625.1

(51) Int. Cl. G06F 3/0482; G06F 3/0485; G06F 9/451

(52) U.S. Cl. CPC G06F 3/0482; G06F 9/451; G06F 3/0485

(57) ABSTRACT

The present application discloses example methods and systems for displaying a dynamic list. In one example method, an information item associated with a dynamic list is received, where the dynamic list corresponds to an account associated with at least one account label. The received information item is associated with an information item label. A determination is made whether the information item label of the received information item matches a particular one of the at least one account label. In response to determining that the information item label of the received information item matches a particular one of the at least one account label, predetermined display processing is performed on the received information item for presentation within the dynamic list on a client device.

### CROSS-REFERENCE TO RELATED APPLICATIONS

This application is a continuation of U.S. application Ser. No. 16/183,419 filed on Nov. 7, 2018, which is a continuation of PCT Application No. PCT/CN2017/086052, filed on May 26, 2017, which claims priority to Chinese Patent Application No. 201610403625.1, filed on Jun. 7, 2016, and each application is hereby incorporated by reference in its entirety.

### TECHNICAL FIELD

The present application relates to the field of Internet technologies, and in particular, to a method, device, apparatus, and system for displaying a dynamic list.

### BACKGROUND

Currently, many Internet products have subscription functions. After a user subscribes to an Internet product, a dynamic list can be generated for the user to browse. Different users' dynamic lists can be different from each other. In addition, though different users may be interested in the same content, weights corresponding to the same content can be different for different people. How to better select content that different users subscribe is important.

In an Internet product (e.g., a website or an application program), each user account can be followed by many other accounts. As such, a dynamic list of the user account may include many content items, and the content items are constantly updated and listed based on their last updated time. A user may need to search for an interested content item from lots of content items. The search process can be slow, and the user obtains the preferred content with low efficiency.

### SUMMARY

Implementations of the present application provide a method, a device, an apparatus, and a system for displaying a dynamic list, to resolve a technical problem in the existing technology that a user obtains preferred content with low efficiency when browsing a dynamic list.

An implementation of the present application discloses a method for displaying a dynamic list, including the following: obtaining an information item in a dynamic list corresponding to an account and the information item label; matching an information item label with an account label; and performing predetermined display processing on a matched information item that has the same label as the account.

An implementation of the present application discloses an apparatus for displaying a dynamic list, including an acquisition module, configured to obtain an information item in a dynamic list corresponding to an account and the information item label; a matching module, configured to match an information item label with an account label; and a display module, configured to perform predetermined display processing on a matched information item that has the same label as the account.

An implementation of the present application further provides a terminal device, including a processor and a memory configured to store an instruction that can be executed by the processor. The instruction that can be executed by the processor includes the following: obtaining an information item in a dynamic list corresponding to an account and an information item label; matching an information item label with an account label; and performing predetermined display processing on a matched information item that has the same label as the account.

An implementation of the present application further provides a mobile device, including a processor and a communications component. The processor is coupled to the communications component. The communications component is configured to obtain an information item in a dynamic list corresponding to an account and an information item label. The processor is configured to match an information item label with an account label, and perform predetermined display processing on a matched information item that has the same label as the account.

An implementation of the present application further provides a computer device, including a processor and a network adapter. The processor is coupled to the network adapter. The network adapter is configured to obtain an information item in a dynamic list corresponding to an account and an information item label. The processor is configured to match an information item label with an account label, and perform predetermined display processing on a matched information item that has the same label as the account.

An implementation of the present application further provides a terminal device used in a means of transportation, including an embedded processor and an embedded communications apparatus. The embedded processor is coupled to the embedded communications apparatus. The embedded communications apparatus is configured to obtain an information item in a dynamic list corresponding to an account and an information item label. The embedded processor is configured to match an information item label with an account label, and perform predetermined display processing on a matched information item that has the same label as the account.

An implementation of the present application further provides a user interface system, including a processing component and an input component. The processing component is coupled to the input component. The input component is configured to obtain an information item in a dynamic list corresponding to an account and an information item label. The processing component is configured to match an information item label with an account label, and perform predetermined display processing on a matched information item that has the same label as the account.

The at least one previous technical solution used in the implementations of the present application can achieve the following beneficial effects: An information item and an information item label are obtained, an information item label is matched with a label of a local account, and display processing is performed on a matched information item that has the same label as the account. As such, a user can quickly browse preferred content.

### BRIEF DESCRIPTION OF DRAWINGS

The accompanying drawings here are used to provide further understanding of the present application, and constitute a part of the present application. Example implementations of the present application and descriptions of the implementations are used to explain the present application, and do not constitute an improper limitation to the present application. In the accompanying drawings:

FIG. 1 is a block diagram illustrating a system for displaying a dynamic list, according to an implementation of the present application;

FIG. 2 is a schematic diagram illustrating matching an information item label with a label of a user account and marking an information item that has the same label as the user account, according to an implementation of the present application;

FIG. 3 is a schematic diagram illustrating highlighting a marked information item, according to an implementation of the present application;

FIG. 4 is a flowchart illustrating hierarchical displaying of a marked information item and a dynamic list, according to an implementation of the present application;

FIG. 5 is a schematic diagram illustrating hierarchical displaying of a marked information item and a dynamic list, according to an implementation of the present application;

FIG. 6 is a schematic diagram illustrating matching an information item label with a label of a user account, and selecting an information item that has the same label as the user account, according to an implementation of the present application;

FIG. 7 is a flowchart illustrating a method for displaying a dynamic list, according to an implementation of the present application;

FIG. 8 is a flowchart illustrating another method for displaying a dynamic list, according to an implementation of the present application;

FIG. 9 is a flowchart illustrating another method for displaying a dynamic list, according to an implementation of the present application;

FIG. 10 is a block diagram illustrating an apparatus for displaying a dynamic list, according to an implementation of the present application;

FIG. 11 is a block diagram illustrating a terminal device, according to an implementation of the present application;

FIG. 12 is a block diagram illustrating a mobile device, according to an implementation of the present application;

FIG. 13 is a block diagram illustrating a computer device, according to an implementation of the present application;

FIG. 14 is a block diagram illustrating a terminal device used in a means of transportation, according to an implementation of the present application;

FIG. 15 is a schematic diagram illustrating a user interface system, according to an implementation of the present application;

FIG. 16 is a flowchart illustrating an example of a computer-implemented method for displaying a dynamic list, according to an implementation of the present disclosure; and

FIG. 17 is a flowchart illustrating an example of performing predetermined display processing on a received information item for presentation within a dynamic list, according to an implementation of the present disclosure.

### DESCRIPTION OF IMPLEMENTATIONS

To make the objectives, technical solutions, and advantages of the present application clearer, the following clearly and comprehensively describes the technical solutions of the present application with reference to the specific implementations and the corresponding accompanying drawings of the present application. Apparently, the described implementations are some rather than all of the implementations of the present application. All other implementations obtained by a person of ordinary skill in the art based on the implementations of the present application without creative efforts shall fall within the protection scope of the present application.

The technical solutions provided by the implementations of the present application are described in detail below with reference to the accompanying drawings.

In the implementations of the present application, labels are added to an information item posted by a user account and each user account. When refreshing a dynamic list, a terminal device obtains an information item posted by a second account followed by a first account that logs in locally and an information item label, and matches an information item label with a label of the first account. If there is the same label, the same label is used to mark an information item that has the same label as the first account, and the information item can also be distinctly displayed. For example, a highlighted method or a hierarchical method is used for displaying. Therefore, the information item is marked with the same label as the first account, and a user can browse preferred content more quickly when browsing the dynamic list.

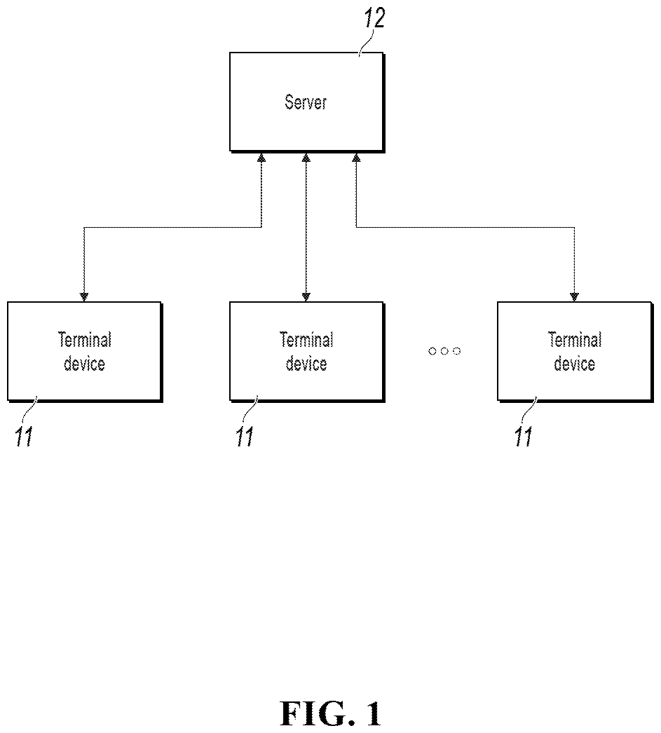

FIG. 1 illustrates a system for displaying a dynamic list, according to an implementation of the present application. The system includes a terminal device 11 and a server 12.

A user completes a login operation by using a user account in an application program running on the terminal device 11 or an open webpage. There is a mapping relationship between user accounts if a user account follows another. One user account can follow a plurality of other user accounts, and each user account can also be followed by a plurality of other user accounts. In this implementation of the present application, a user account that the terminal device 11 logs in is referred to as a first account, and other user accounts followed by the first account are collectively referred to as a second account.

The mapping relationship between user accounts is stored on the server 12. The terminal device 11 can locally store a list of second accounts followed by the first account, and update and maintain the list by using the server 12.

The terminal device 11 can be a mobile phone, a computer, a digital broadcast terminal device, a message transceiver device, a game console, a tablet device, a medical device, a fitness device, a personal digital assistant, etc., and the server 12 can be a server device provided by a developer, an operator of a website, or an application program.

After the user completes the login operation on the terminal device 11 by using the first account, a dynamic list in an application program or a browser interface can be displayed. The dynamic list is used to display an information item posted by the second account followed by the first account.

The server 12 further maintains a label library. The label library can directly include a plurality of labels. Alternatively, the label library can include a plurality of label types, and each label type further includes a plurality of labels.

A user who uses the second account posts a new information item by using another terminal device 11, and the newly posted information item is uploaded to the server 12. The server 12 can analyze content in the newly posted information item to determine a label corresponding to the information item. For example, the server 12 performs semantic analysis on text content in the information item, and matches the label to be added to the information item based on an analysis result. The server 12 can further perform feature identification on a picture in the information item to determine content of the picture and further obtain the label to be added to the information item. In addition, the server 12 can further determine the label corresponding to the information item based on attribute information of the information item. For example, the information item includes attributes such as price, location, and merchandise category, and the corresponding label can be added to the information item based on the attribute information.

After adding the label to the information item posted by the second account, the server 12 pushes, based on the stored mapping relationship between user accounts, the information item posted by the second account and the added label to the terminal device 11 where the first account following the second account is located.

When the terminal device 11, where the first account is located, refreshes the dynamic list, the terminal device 11 obtains the information item posted by the second account and the label of the information item. To refresh the dynamic list, the terminal device 11 can periodically request dynamic list data from the server 12 when the terminal device 11 is communicatively connected to the server 12. Alternatively, the terminal device 11 requests dynamic list data from the server 12 based on a user's operation on the terminal device 11. For example, the terminal device 11 requests latest dynamic list data from the server 12 when detecting that the user drags the dynamic list downwards.

The terminal device 11 matches the label of the information item with a label of the first account, to determine whether the information item has the same label as the first account.

A user account label can be added by the server 12. The label that the server 12 adds to the user account and the label that the server 12 adds to the information item can come from the same label library, to ensure that the two can be correctly matched. If the two come from different label libraries, a mapping relationship between different label libraries further needs to be established to ensure that the matching can be performed normally. The server 12 can perform statistical analysis on browsing behavior of each user account, determine content frequently browsed or searched by the user account, and determine a label to be added to the user account based on the content. As such, preferred content to each user account can be analyzed, and a label can be added to the user account based on the preferred content to the user account, so that a preferred information item to the user account can be matched for the user account subsequently.

A user account label can be added by a user. An application program or webpage client software running on the terminal device 11 also sets a label library corresponding to the server 12, and the user performs a selection operation on the terminal device 11 to determine the label to be added to the user account. As such, the user can have the right to select the label, and the user determines the account label used by the user, so that the user's right is better respected.

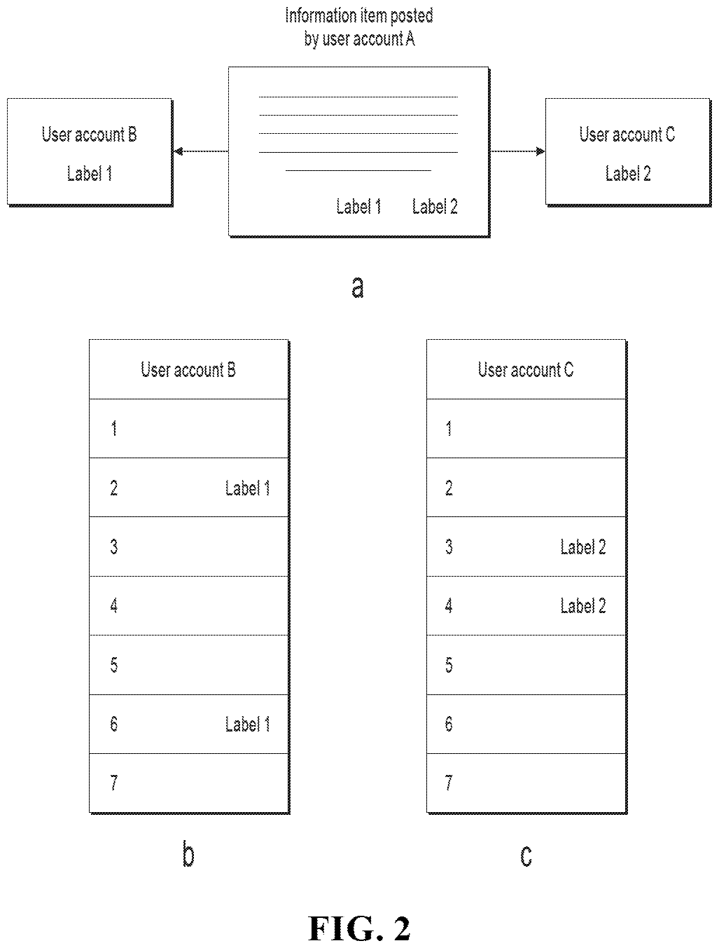

As shown in a in FIG. 2, label 1 and label 2 are added to information items posted by user account A in the server. Both user account B and user account C follow user account A, and the server distributes the information items to terminal devices where user account B and user account C are located. Label 1 is added to user account B, and label 2 is added to user account C. The terminal device where user account B is located matches the labels of the information items with the label of user account B, for the same label 1. The terminal device where user account C is located matches the labels of the information items with the label of user account C, for the same label 2. The same label of the information items and the user account is displayed in a dynamic list, and the corresponding information item is marked with the same label that is matched. As shown in b in FIG. 2, user account B has label 1, and the second information item and the sixth information item in a dynamic list of user account B have label 1. In this case, label 1 is displayed on locations of the second information item and the sixth information item, and the information items that have the same label as user account B are marked with the same label 1. As shown in c in FIG. 2, user account C has label 2, and the third information item and the fourth information item in a dynamic list of user account C have the same label 2. In this case, label 2 is displayed on locations of the third information item and the fourth information item, and the information items that have the same label as user account C are marked with the same label 2.

As such, the information item is marked with the same label that is matched, so that the user of the terminal device 11 can locate preferred content to the user by identifying labels.

In an implementation, the terminal device 11 can further distinctly display the information item that has the same label as the first account. The following methods are used to determine whether to distinctly display the information item.

A1. Determine, based on an interaction method of the user for the dynamic list, whether to distinctly display the information item that has the same label as the first account.

When the user performs interaction by using a touchscreen, if the terminal device 11 detects an operation of continuously dragging the dynamic list displayed on a screen, the terminal device 11 distinctly displays the information item that has the same label as the first account. For example, the terminal device 11 detects that the user drags the dynamic list upwards twice continuously.

Alternatively, when the user perform interaction by using an external device interface such as a key, a keyboard, and a mouse of the terminal device 11, if the terminal device 11 detects an operation of continuously scrolling the dynamic list displayed on a screen, the terminal device 11 distinctly displays the information item that has the same label as the first account. For example, when detecting that the user continuously scrolls the dynamic list by using a direction key of the terminal device, or continuously scrolls the dynamic list by using a direction key on the keyboard or a scroll wheel of the mouse, the terminal device distinctly displays the information item that has the same label as the first account.

Each of the previously described interaction methods indicates that the user wants to quickly browse an information item in the dynamic list, and the information item that has the same label as the first account is distinctly displayed so that the user can browse the preferred content more accurately in this quick browsing process.

A2. Determine whether to distinctly display the information item that has the same label as the first account based on a location where the information item is displayed on a screen.

Information items on the dynamic list can be scrolled in response to a user's operation. When an information item that has the same label as the first account is loaded and displayed in the dynamic list, it is determined whether a display location of the information item is located in the first entry of the current dynamic list. If the display location of the information item is located in the first entry of the current dynamic list, the information item is distinctly displayed.

Alternatively, a display area is predetermined on the screen, and the display area is an area that is determined based on a user's visual habit and can be directly seen by the user. For example, the area is the upper part of the screen, or the area is determined based on a height of the screen and a height of each information item in the dynamic list. For example, if a total of six information items can be displayed on the screen, a display area where the first four information items are located from top to bottom is used as the predetermined display area. When an information item that has the same label as the first account is loaded and displayed in the dynamic list, it is determined whether a display location of the information item falls within the predetermined display area. When the display location of the information item falls within the predetermined display area, the information item is distinctly displayed. Alternatively, when the display location of the information item falls beyond the predetermined display area, the next information item is loaded so that the information item move upwards to the predetermined display area, and then the information item is distinctly displayed.

In this method, the information item that has the same label as the first account can be distinctly displayed when the information item is located in the display area that can be browsed by the user, so that the user can browse the preferred content.

In addition, the methods for determining whether to distinctly display the information item based on the interaction method and the display location of the information item can be combined. In other words, the information item that has the same label as the first account is distinctly displayed when a user's operation of quickly browsing the dynamic list is detected and the information item that has the same label as the first account is located in the predetermined display area.

The information item can be distinctly displayed in the following methods:

B1. Highlight the information item that has the same label as the first account.

Display brightness of the dynamic list is controlled, to improve display brightness of the information item that has the same label as the first account, or reduce display brightness of an information item that does not have the same label as the first account, or both.

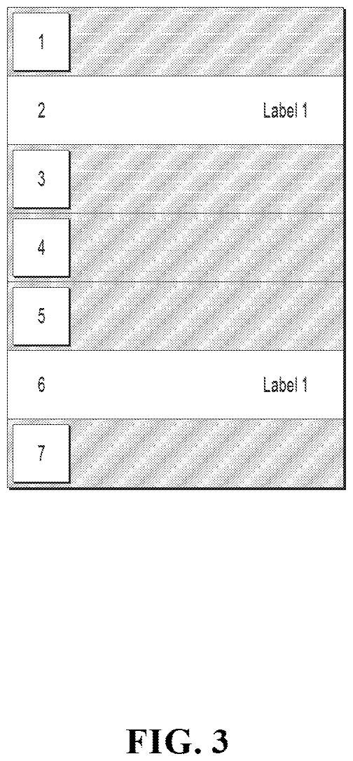

As such, the display brightness of the information item marked with the same label as the first account is greater than that of another information item. As shown in FIG. 3, the second information item and the sixth information item marked with the same label 1 are highlighted. Therefore, the user can intuitively view the information item that has the same label as the first account.

B2. Hierarchically display the information item that has the same label as the first account and the dynamic list.

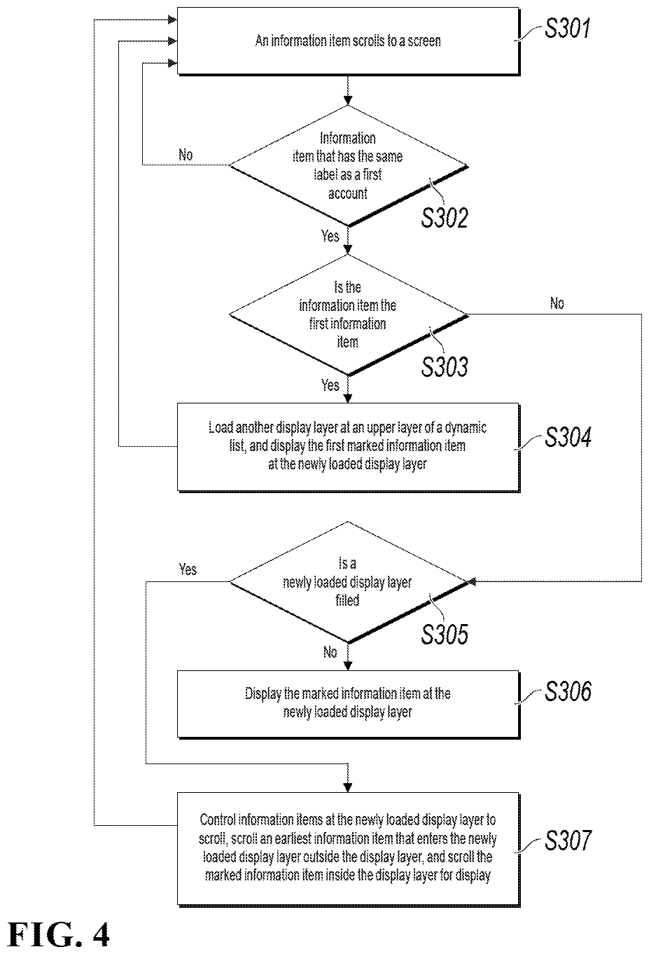

The information item marked with the same label as the first account is displayed at an upper layer of the dynamic list, so that the information item that has the same label as the first account can stand out from the original dynamic list. The process is shown in FIG. 4.

S301. An information item scrolls to a screen.

S302. Determine whether there is an information item that has the same label as a first account. When a determining result is yes, step S303 is performed; or when a determining result is no, step S301 is performed again.

S303. Determine whether the information item is the first information item that has the same label as the first account. When a determining result is yes, step S304 is performed; or when a determining result is no, step S305 is performed.

S304. Load another display layer at an upper layer of a dynamic list, display the first marked information item at the newly loaded display layer, and return to step S301.

S305. Determine whether the newly loaded display layer is filled. When a determining result is no, step S306 is performed; or when a determining result is yes, step S307 is performed.

S306. Display the marked information item at the newly loaded display layer, and return to step S301.

S307. Control information items at the newly loaded display layer to scroll, scroll an earliest information item that enters the newly loaded display layer outside the display layer, and scroll the marked information item inside the display layer for display; and return to step S301.

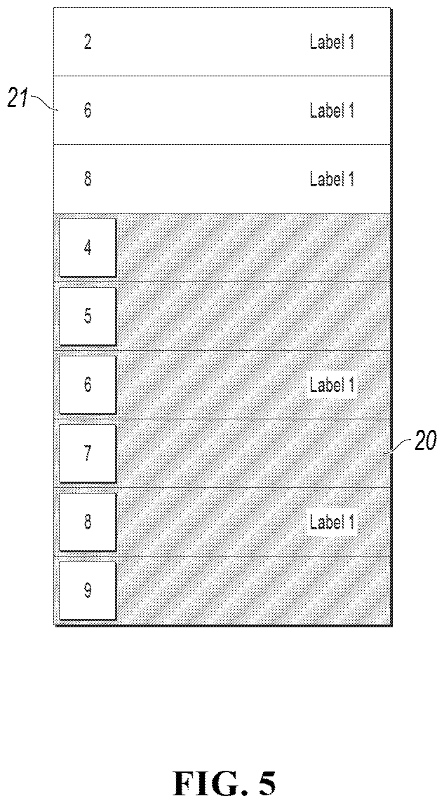

As shown in FIG. 5, a newly loaded display layer 21 is located at an upper layer of an original dynamic list 20, and the second information item, the sixth information item, and the eighth information item that have the same label as a user account in the original dynamic list 20 are displayed at the display layer 21. As more information items that have the same label as the user account scroll to a screen, information items displayed at the display layer 21 also gradually increase. When the display layer 21 is filled with information items that have the same label as the user account, an information item list at the display layer 21 also starts to scroll accordingly.

Whether the newly loaded display layer is filled can be determined by using a width of information items and a width of the newly loaded display layer. For example, a maximum of 10 information items can be simultaneously displayed on the screen, and nine information items can be simultaneously displayed at the newly loaded display layer. The number of information items that stand out from the dynamic list to the newly loaded display layer for display is calculated. When the number of information items that stand out to the newly loaded display layer is greater than or equal to 9, the information items start to scroll at the newly loaded display layer so that the first information item that stands out to the newly loaded display layer for display scrolls outside the display layer, and an information item that newly stands out scrolls to the display layer for display. When the number of information items that stand out to the newly loaded display layer for display is less than 9, the marked information item is directly displayed at the newly loaded display layer.

The information items that have the same label as the first account stand out from the dynamic list to the newly loaded display layer for display, so that the information items that have the same label as the first account are collected together for browsing so that the user can browse the preferred content more quickly.

B3. Combine B1 and B2 to highlight an information item at a newly loaded display layer so that display brightness of the original dynamic list is reduced accordingly.

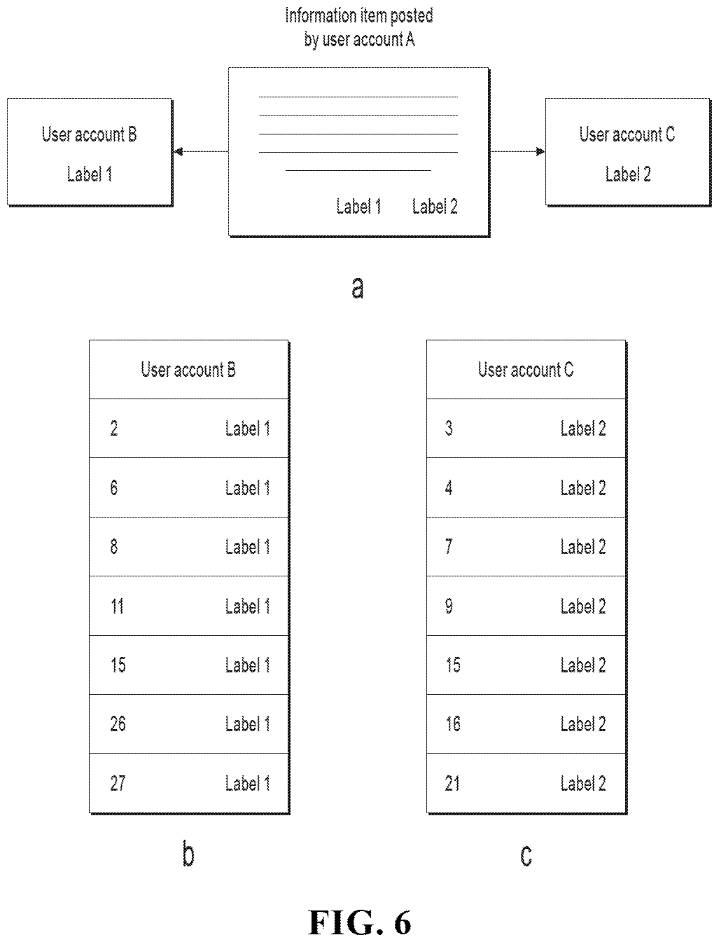

In another implementation, after the label of the information item is matched with the label of the user account, information items in the dynamic list are screened based on the same label that is matched, and the information item that has the same label as the user account is displayed as information in the dynamic list. As shown in a in FIG. 6, label 1 and label 2 are added to information items posted by user account A in the server. Both user account B and user account C follow user account A, and the server distributes the information items to terminal devices where user account B and user account C are located. Label 1 is added to user account B, and label 2 is added to user account C. The terminal device where user account B is located matches the labels of the information items with the label of user account B, for the same label 1. The terminal device where user account C is located matches the labels of the information items with the label of user account C, for the same label 2. In this case, as shown in b in FIG. 6, only information items that have the same label 1 are displayed in a dynamic list of user account B, and as shown in c in FIG. 6, only information items that have the same label 2 are displayed in a dynamic list of user account C. The information items in the dynamic list are screened by using the same label that is matched, and content related to the user account is displayed, so that the user can browse the preferred content more quickly.

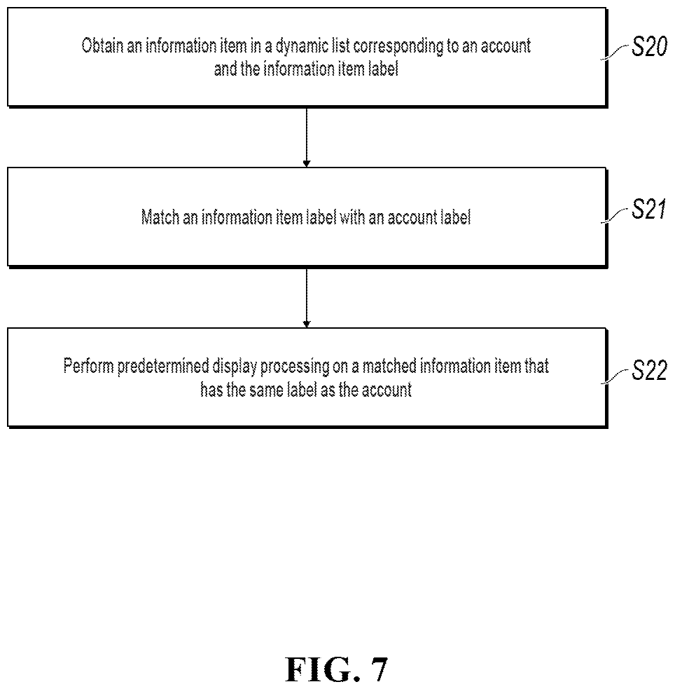

Based on the previous description, from the perspective of the terminal device 11, an implementation of the present application provides a method for displaying a dynamic list. As shown in FIG. 7, the method includes the following steps:

S20. Obtain an information item in a dynamic list corresponding to an account and the information item label.

S21. Match an information item label with an account label.

S22. Perform predetermined display processing on a matched information item that has the same label as the account.

Step S22 includes the following: displaying the same label of the information item and the account in the dynamic list (marking the corresponding information item by using the same label); distinctly displaying the information item that has the same label as the account when a scrolling operation performed on the dynamic list is detected; and displaying, as information in the dynamic list, the information item that has the same label as the account. As such, a user can quickly locate preferred content in the dynamic list.

In an implementation, step S22 further includes the following: displaying the same label of the information item and the account in the dynamic list. The corresponding information item is marked with the same label that is matched, so that the user can locate the preferred content.

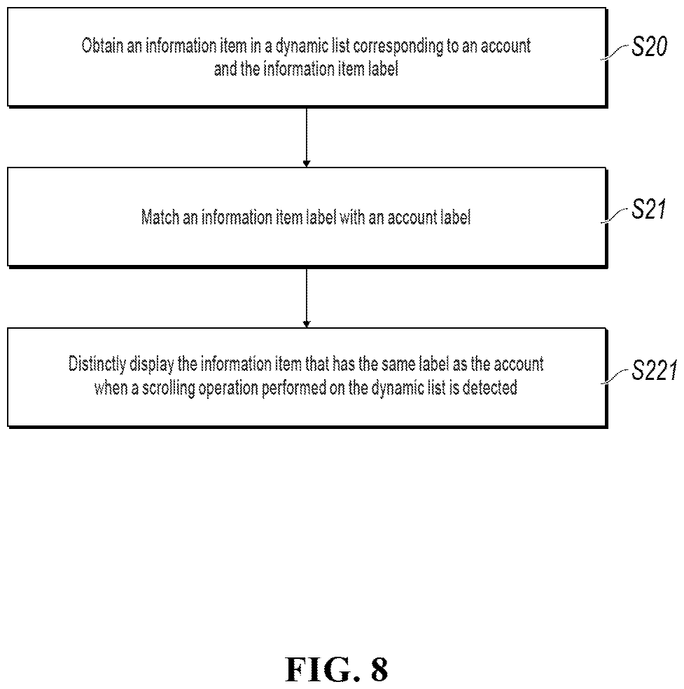

In an implementation, step S22 further includes the following step. As shown in FIG. 8, in step S221, the information item that has the same label as the account is distinctly displayed when a scrolling operation performed on the dynamic list is detected.

When the scrolling operation is detected, it indicates that the user is browsing the dynamic list. In this case, when the information item that has the same label as the account is distinctly displayed, the user can quickly browse a preferred information item.

In an implementation, step S221 can further include the following: detecting an operation of continuously scrolling the dynamic list or an operation of continuously dragging the dynamic list on a screen; and distinctly displaying the information item that has the same label as the account.

When the user wants to quickly browse the dynamic list by performing a quick scrolling operation, if the information item that has the same label as the account is distinctly displayed, the user can quickly browse the preferred content, to improve browsing efficiency.

In an implementation, the distinctly displaying the information item in step S221 can further include the following: controlling display brightness of the dynamic list, so that display brightness of the information item that has the same label as the account is greater than that of another information item. An information item that the user may want to first browse is prompted through differentiation between display brightness.

In an implementation, the distinctly displaying the information item in step S221 can further include the following: hierarchically displaying the information item that has the same label as the account and the dynamic list, so that the information item that has the same label as the account is displayed at an upper layer of the dynamic list.

As such, the information item marked with the same label as the account stands out from the dynamic list, so that the user can focus on the information item marked with the same label as the account.

In an implementation, the hierarchical displaying method further includes the following: determining whether the information item is the first information item that has the same label as the account when the information item that has the same label as the account scrolls to a screen; and loading another display layer at the upper layer of the dynamic list, and displaying the first information item that has the same label as the account at the display layer when it is determined that the information item is the first information item that has the same label as the account; and determining whether the display layer is filled when another information item that has the same label as the account in the dynamic list scrolls to the screen; and controlling information items at the display layer to scroll when the display layer is filled, to scroll an earliest information item that enters the display layer outside the display layer, and scroll the another information item that has the same label as the account inside the display layer.

When the first marked information item appears, the hierarchical displaying is triggered. When there are many information items displayed at the newly loaded display layer, scrolling browsing is performed on the information items at the display layer.

In an implementation, the method for displaying a dynamic list can further include the following: receiving a label added by a server to the account; or receiving a label locally added by a user to the account. The label of the user account can be added by the server, or can be added by the user.

In an implementation, step S20 further includes the following: obtaining an information item posted by a second account followed by a first account that logs in locally, and a label added by a server to the information item based on content or an attribute of the information item. The label of the information item is added by the server based on the content or attribute information of the information item.

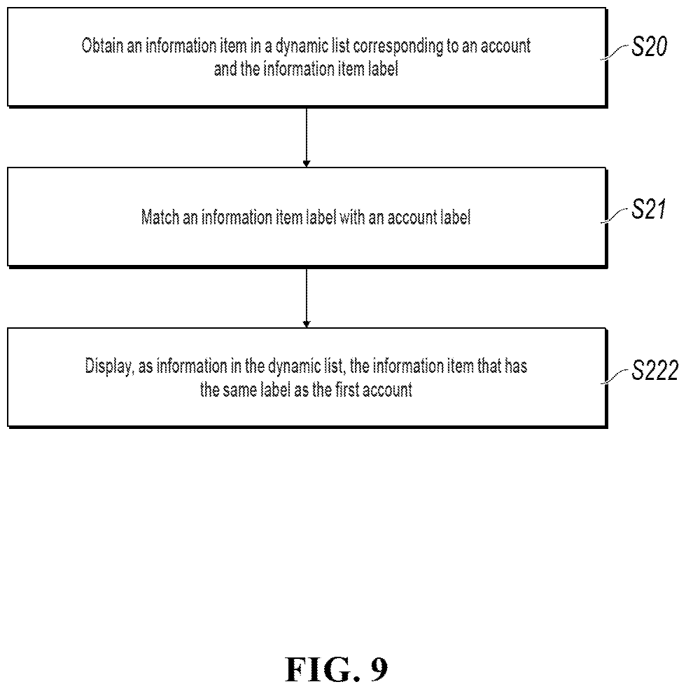

In another implementation, a method for displaying a dynamic list is further provided. As shown in FIG. 9, the method includes the following steps.

S20. Obtain an information item posted by a second account and an information item label followed by an account.

S21. Match an information item label with an account label.

S222. Display, as information in a dynamic list, the information item that has the same label as the first account.

In this implementation, information items in the dynamic list are screened by using the same label that is matched, and content related to the user account is displayed, so that a user can browse the preferred content more quickly.

The following apparatus implementations of the present application are used to perform the previously described method implementations of the present application.

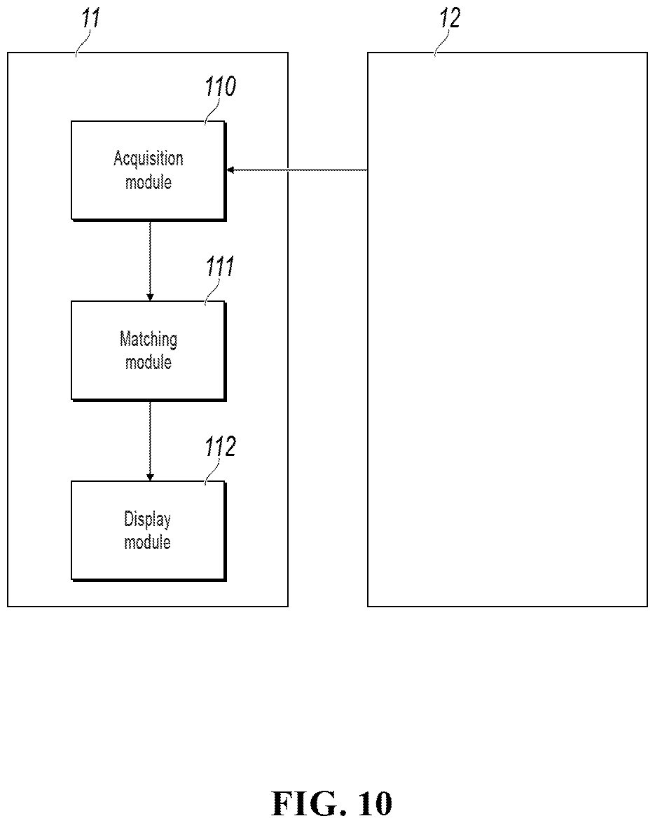

As shown in FIG. 10, an implementation of the present application provides an apparatus for displaying a dynamic list. The apparatus is located on a terminal device side, and includes an acquisition module 110, configured to obtain an information item in a dynamic list corresponding to an account and an information item label; a matching module 111, configured to match an information item label with an account label; and a display module 112, configured to perform predetermined display processing on a matched information item that has the same label as the account.

In an implementation, the display module 112 further includes a first display submodule, configured to display the same label of the information item and the account in the dynamic list.

In an implementation, the display module 112 further includes a second display submodule, configured to distinctly display the information item that has the same label as the account when a scrolling operation performed on the dynamic list is detected.

In an implementation, the second display submodule further includes a detection unit, configured to detect an operation of continuously scrolling the dynamic list or an operation of continuously dragging the dynamic list on a screen; and a first display unit, configured to distinctly display the information item that has the same label as the account.

In an implementation, the second display submodule further includes a second display unit, configured to control display brightness of the dynamic list, so that display brightness of the information item that has the same label as the account is greater than that of another information item.

In an implementation, the second display submodule further includes a third display unit, configured to hierarchically display the information item that has the same label as the account and the dynamic list, so that the information item that has the same label as the account is displayed at an upper layer of the dynamic list.

In an implementation, the third display unit further includes a first determining subunit, configured to determine whether the information item is the first information item that has the same label as the account when the information item that has the same label as the account scrolls to a screen; and a first display subunit, configured to load another display layer at the upper layer of the dynamic list and display the first information item that has the same label as the account at the display layer, when it is determined that the information item is the first information item that has the same label as the account.

In an implementation, the third display unit further includes a second determining subunit, configured to determine whether the display layer is filled when another information item that has the same label as the account scrolls to the screen; and a second display subunit, configured to control information items at the display layer to scroll when the display layer is filled, to scroll an earliest information item that enters the display layer outside the display layer, and scroll the another information item that has the same label as the account inside the display layer.

In an implementation, the apparatus for displaying a dynamic list further includes a receiving module, configured to receive a label added by a server to the account; or receive a label locally added by a user to the account.

In an implementation, the acquisition module 110 further includes an acquisition submodule, configured to obtain an information item posted by a second account followed by a first account that logs in locally, and a label added by a server to the information item based on content or an attribute of the information item.

In an implementation, the display module 112 further includes a third display submodule, configured to display, as information in the dynamic list, the information item that has the same label as the account.

In addition, in this implementation of the present application, the previously described functional modules can be implemented by using a hardware processor.

An implementation of the present application further provides a terminal device, including a processor and a memory configured to store an instruction that can be executed by the processor. The instruction that can be executed by the processor includes the following: obtaining an information item in a dynamic list corresponding to an account and an information item label; matching an information item label with an account label; and performing predetermined display processing on a matched information item that has the same label as the account.

In an implementation, the performing predetermined display processing on a matched information item that has the same label as the account includes the following: displaying the same label of the information item and the account in the dynamic list.

In an implementation, the performing predetermined display processing on a matched information item that has the same label as the account includes the following: distinctly displaying the information item that has the same label as the account when a scrolling operation performed on the dynamic list is detected.

In an implementation, the distinctly displaying the information item that has the same label as the account when a scrolling operation performed on the dynamic list is detected includes the following: detecting an operation of continuously scrolling the dynamic list or an operation of continuously dragging the dynamic list on a screen; and distinctly displaying the information item that has the same label as the account.

In an implementation, the distinctly displaying the information item that has the same label as the account includes the following: controlling display brightness of the dynamic list, so that display brightness of the information item that has the same label as the account is greater than that of another information item.

In an implementation, the distinctly displaying the information item that has the same label as the account includes the following: hierarchically displaying the information item that has the same label as the account and the dynamic list, so that the information item that has the same label as the account is displayed at an upper layer of the dynamic list.

In an implementation, the hierarchically displaying the information item that has the same label as the account and the dynamic list, so that the information item that has the same label as the account is displayed at an upper layer of the dynamic list includes the following: determining whether the information item is the first information item that has the same label as the account when the information item that has the same label as the account scrolls to a screen; and loading another display layer at the upper layer of the dynamic list, and displaying the first information item that has the same label as the account at the display layer when it is determined that the information item is the first information item that has the same label as the account.

In an implementation, the hierarchically displaying the information item that has the same label as the account and the dynamic list, so that the information item that has the same label as the account is displayed at an upper layer of the dynamic list further includes the following: determining whether the display layer is filled when another information item that has the same label as the account scrolls to the screen; and controlling information items at the display layer to scroll when the display layer is filled, to scroll an earliest information item that enters the display layer outside the display layer, and scroll the another information item that has the same label as the account inside the display layer.

In an implementation, the instruction that can be executed by the processor further includes the following: receiving a label added by a server to the account; or receiving a label locally added by a user to the account.

In an implementation, the obtaining an information item posted by a second account followed by an account and an information item label includes the following: obtaining an information item posted by a second account followed by a first account that logs in locally, and a label added by a server to the information item based on content or an attribute of the information item.

In an implementation, the performing predetermined display processing on a matched information item that has the same label as the account includes the following: displaying, as information in the dynamic list, the information item that has the same label as the account.

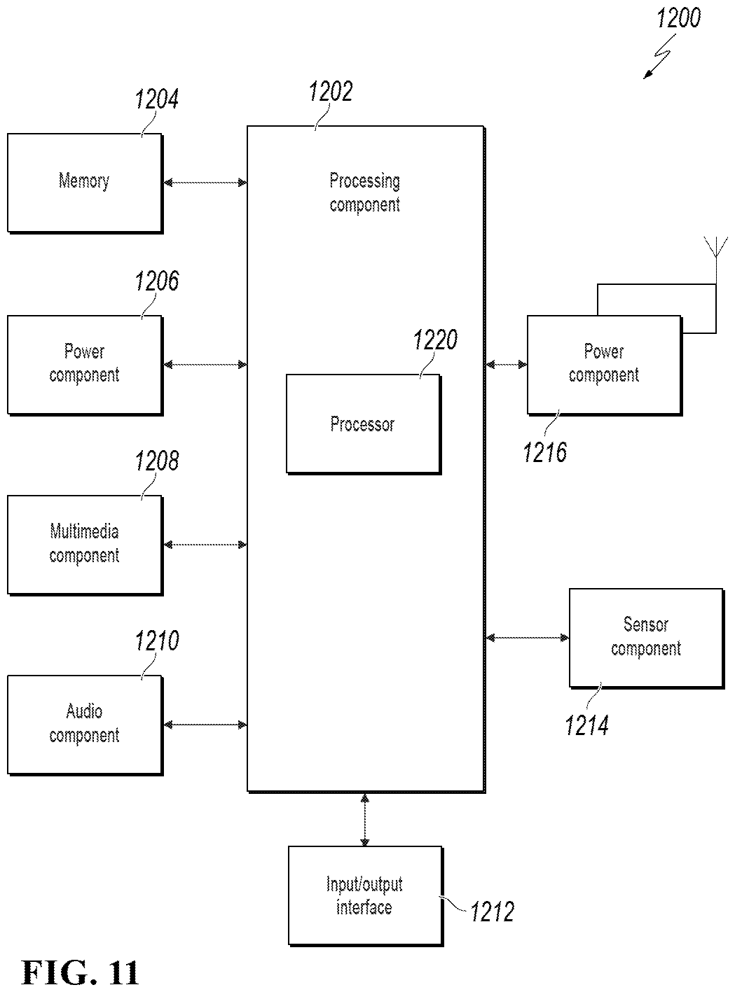

FIG. 11 is a block diagram illustrating a terminal device, provided in the previous implementation of the present application, according to an example implementation. For example, the terminal device 1200 can be a mobile phone, a computer, a digital broadcast terminal device, a message transceiver device, a game console, a tablet device, a medical device, a fitness device, or a personal digital assistant.

The terminal device 1200 can include one or more of the following components: a processing component 1202, a memory 1204, a power component 1206, a multimedia component 1208, an audio component 1210, an input/output (I/O) interface 1212, a sensor component 1214, and a communications component 1216.

The processing component 1202 usually controls operations of the terminal device 1200, for example, operations related to display, telephone calls, data communication, camera operations, and recording operations. The processing component 1202 can include one or more processors 1220 to execute an instruction, so as to complete all or some of the steps of the previously described method. In addition, the processing component 1202 can include one or more modules, so that the processing component 1202 can interact with another component. For example, the processing component 1202 can include a multimedia module, so that the multimedia component 1208 can interact with the processing component 1202.

The memory 1204 is configured to store various types of data to support operations in the device 1200. Examples of the data include an instruction for any application program or method to be operated on the terminal device 1200, contact data, phonebook data, a message, a picture, a video, etc. The memory 1204 can be implemented by any type of volatile or non-volatile storage device or a combination thereof, such as a static random access memory (SRAM), electrically erasable programmable read-only memory (EEPROM), an erasable programmable read only memory (EPROM), a programmable read-only memory (PROM), a read-only memory (ROM), a magnetic memory, a flash memory, a disk, or an optical disc.

The power component 1206 provides power for various components of the terminal device 1200. The power component 1206 can include a power management system, one or more power supplies, and another component that is associated with generation, management, and allocation of electric power for the terminal device 1200.

The multimedia component 1208 includes a screen that provides an output interface between the terminal device 1200 and a user. In some implementations, the screen can include a liquid crystal display (LCD) and a touch panel (TP). If the screen includes the touch panel, the screen can be implemented as a touchscreen, to receive an input signal from the user. The touch panel includes one or more touch sensors to sense touching, sliding, and a gesture on the touch panel. The touch sensor can not only sense a boundary of a touching or sliding operation, but also sense duration and pressure related to the touching or sliding operation. In some implementations, the multimedia component 1208 includes a front-facing camera and/or a rear-facing camera. When the device 1200 is in an operation mode such as a shooting mode or a video mode, the front-facing camera and/or the rear-facing camera can receive external multimedia data. Each front-facing camera or rear-facing camera can be a fixed optical lens system or has a focal length and an optical zoom capability.

The audio component 1210 is configured to output and/or input an audio signal. For example, the audio component 1210 includes a microphone (MIC). When the terminal device 1200 is in an operation mode such as a call mode, a recording mode, and a voice recognition mode, the microphone is configured to receive an external audio signal. The received audio signal can be further stored in the memory 1204 or sent by using the communications component 1216. In some implementations, the audio component 1210 further includes a speaker, configured to output an audio signal.

The I/O interface 1212 provides an interface between the processing component 1202 and a peripheral interface module. The peripheral interface module can be a keyboard, a tapping wheel, a button, etc. The button can include but is not limited to a home page button, a volume button, a start button, and a lock button.

The sensor component 1214 includes one or more sensors, configured to evaluate a status of each aspect of the terminal device 1200. For example, the sensor component 1214 can detect an on/off state of the device 1200, and relative locations of components. For example, the components are a display and a keypad of the terminal device 1200. The sensor component 1214 can further detect a location change of the terminal device 1200 or a component of the terminal device 1200, existence or non-existence of contact of the user with the terminal device 1200, orientation or acceleration/deceleration of the terminal device 1200, and a temperature change of the terminal device 1200. The sensor component 1214 can include a proximity sensor, configured to detect existence of a nearby object when there is no physical contact. The sensor component 1214 can further include an optical sensor such as a CMOS or CCD image sensor, used in an imaging application. In some implementations, the sensor component 1214 can further include an acceleration sensor, a gyro sensor, a magnetic sensor, a pressure sensor, or a temperature sensor.

The communications component 1216 is configured to facilitate communication between the terminal device 1200 and another device in a wired or wireless way. The terminal device 1200 can access a wireless network based on a communication standard, such as WiFi, 2G, or 3G, or a combination thereof. In an example implementation, the communications component 1216 receives a broadcast signal or broadcast related information from an external broadcast management system by using a broadcast channel. In an example implementation, the communications component 1216 further includes a near field communication (NFC) module, to facilitate short-range communication. For example, the NFC module can be implemented by using a radio frequency identification (RFID) technology, an infrared data association (IrDA) technology, an ultra-wideband (UWB) technology, a Bluetooth (BT) technology, and other technologies.

In an example implementation, the terminal device 1200 can be implemented by one or more application-specific integrated circuits (ASIC), digital signal processors (DSP), digital signal processing devices (DSPD), programmable logic devices (PLD), field programmable gate arrays (FPGA), controllers, microcontrollers, microprocessors, or other electronic elements, to perform the previously described method for displaying a dynamic list.

An example implementation further provides a non-transitory computer readable storage medium including an instruction, for example, the memory 1204 including an instruction, and the instruction can be executed by the processor 1220 of the terminal device 1200 to complete the previously described method. For example, the non-transitory computer readable storage medium can be a ROM, a random access memory (RAM), a CD-ROM, a magnetic tape, a floppy disk, or an optical data storage device.

A non-transitory computer readable storage medium is provided. When an instruction in the storage medium is executed by the processor of the terminal device 1200, the terminal device 1200 can perform the previously described method for displaying a dynamic list.

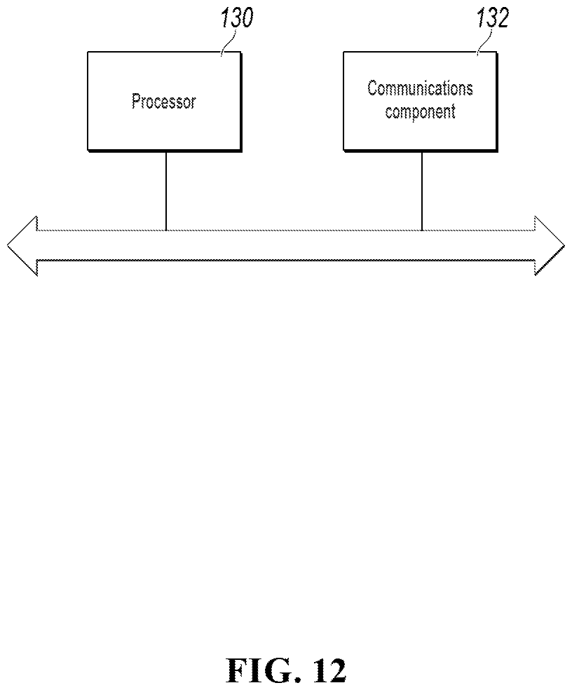

Based on the terminal device provided in the previous implementation of the present application, an implementation of the present application further provides a mobile device. As shown in FIG. 12, the mobile device includes a processor 130 and a communications component 132.

The processor 130 is coupled to the communications component 132. The communications component 132 obtains an information item in a dynamic list corresponding to an account and an information item label. The processor 130 matches an information item label with an account label, and performs predetermined display processing on a matched information item that has the same label as the account.

In an implementation, after matching the label of the information item with the account label, the processor 130 displays the same label of the information item and the account in the dynamic list.

In an implementation, after matching the label of the information item with the account label, the processor 130 displays, as information in the dynamic list, the information item that has the same label as the account.

In another implementation, after matching the label of the information item with the account label, the processor 130 distinctly displays the information item that has the same label as the account when detecting an instruction for performing a scrolling operation on the dynamic list.

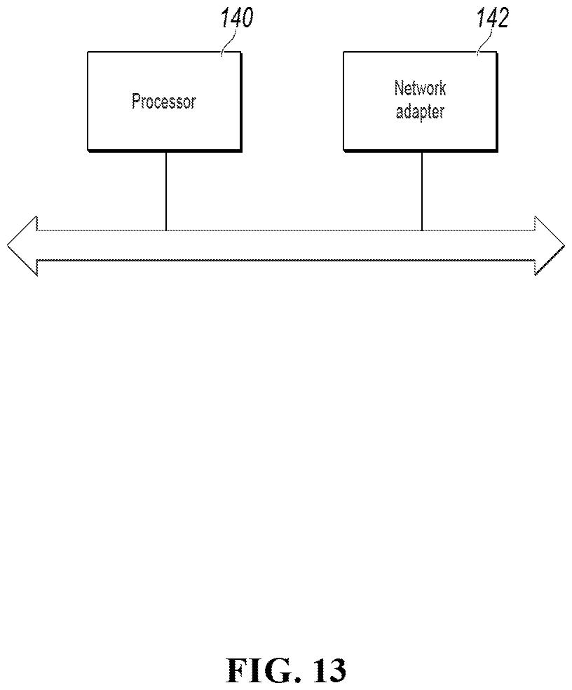

An implementation of the present application further provides a computer device. As shown in FIG. 13, the computer device includes a processor 140 and a network adapter 142. The processor 140 is coupled to the network adapter 142. The network adapter 142 obtains an information item in a dynamic list corresponding to an account and an information item label. The processor 140 matches the label of the information item with an account label, and performs predetermined display processing on a matched information item that has the same label as the account.

In an implementation, after matching the label of the information item with the account label, the processor 140 displays the same label of the information item and the account in the dynamic list.

In an implementation, after matching the label of the information item with the account label, the processor 140 displays, as information in the dynamic list, the information item that has the same label as the account.

In another implementation, after matching the label of the information item with the account label, the processor 140 distinctly displays the information item that has the same label as the account when detecting an instruction for performing a scrolling operation on the dynamic list.

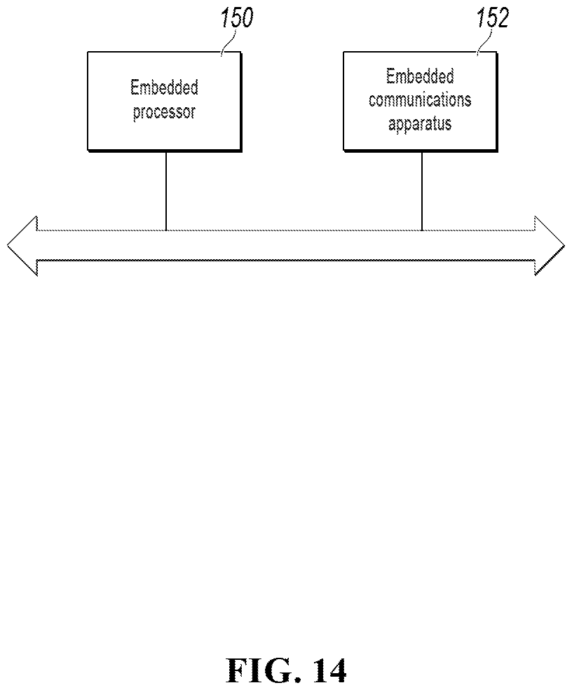

An implementation of the present application further provides a terminal device used in a means of transportation. As shown in FIG. 14, the terminal device includes an embedded processor 150 and an embedded communications apparatus 152.

In actual applications, the terminal device can be integrated into a central control system of the means of transportation, including but not limited to an in-vehicle device, a control device added to the means of transportation after delivery, etc. The terminal device can include other devices in addition to the embedded processor 150 and the embedded communications apparatus 152.

Depending on a type of the means of transportation where the terminal device is installed, the embedded processor 150 can be implemented by various application-specific integrated circuits (ASIC), digital signal processors (DSP), digital signal processing devices (DSPD), programmable logic devices (PLD), field programmable gate arrays (FPGA), controllers, microcontrollers, microprocessors, or other electronic elements, and is configured to perform all or a part of the previously described method for displaying a dynamic list. The embedded processor 150 is coupled to the embedded communications apparatus 152 by using a line inside the means of transportation or a wireless connection. Based on solutions of all or some of the steps in the previously described method for displaying a dynamic list, the embedded processor 150 controls the terminal device used in a means of transportation to display a dynamic list.

Depending on a type of the means of transportation where the terminal device is installed, the embedded communications apparatus 152 can include a plurality of communications apparatuses. For example, if the means of transportation is a vehicle, the plurality of communications apparatuses include an in-vehicle antenna, an in-vehicle WiFi module, etc. The embedded communications apparatus 152 obtains an information item in a dynamic list corresponding to an account that logs in locally and an information item label.

The embedded processor 150 matches an information item label with an account label, and performs predetermined display processing on a matched information item that has the same label as the account.

Depending on a type of the means of transportation where the terminal device is installed, the terminal device used in a means of transportation can further include an embedded display apparatus. The embedded display apparatus can be various display devices used in the industry, for example, a touchscreen having a touch sensing function.

When the embedded display apparatus is implemented as a touchscreen, the embedded processor 150 distinctly displays the information item that has the same label as the first account when detecting a signal for performing a scrolling operation on the dynamic list.

In an implementation, after matching the label of the information item with the account label, the embedded processor 150 displays, as information in the dynamic list, the information item that has the same label as the first account.

In another implementation, after matching the label of the information item with the account label, the embedded processor 150 displays the same label of the information item and the account in the dynamic list.

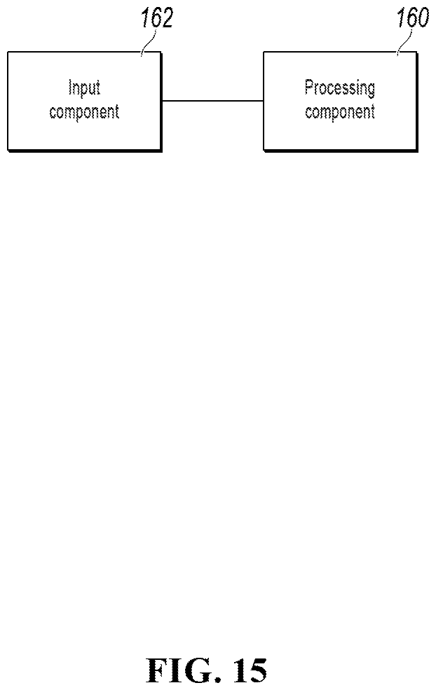

FIG. 15 is a schematic diagram illustrating a user interface system, according to an implementation of the present application. As shown in FIG. 15, the user interface system includes a processing component 160 and an input component 162, and the processing component 160 is coupled to the input component 162.

The input component 162 is configured to obtain an information item in a dynamic list corresponding to an account and an information item label. The processing component 160 matches an information item label with an account label, and performs predetermined display processing on a matched information item that has the same label as the account. In an implementation, as shown in b and c in FIG. 2, matched information items are marked with the same label in the dynamic list.

In an implementation, after matching the label of the information item with the account label, the processing component 160 displays, as information in the dynamic list, the information item that has the same label as the first account. Information items obtained in the dynamic list are screened, as shown in b and c in FIG. 6. In this case, information items with the same label are displayed in the dynamic list after the screening.

In another implementation, after matching the label of the information item with the account label, the processing component 160 distinctly displays the information item that has the same label as the account when detecting an instruction for performing a scrolling operation on the dynamic list. A method for distinctly displaying the information item can be highlighting the information item that has the same label as the account. As shown in FIG. 3, information items that have the same label 1 are highlighted in the dynamic list. In addition, a method for distinctly displaying the information item can be hierarchically displaying the information item that has the same label as the account and the dynamic list. As shown in FIG. 5, information items that have the same label 1 are displayed at a newly loaded display layer 21, and the newly loaded display layer 21 is located above a dynamic list 20.

A person skilled in the art should understand that the implementations of the present application can be provided as a method, a system, or a computer program product. Therefore, the present application can use a form of hardware only implementations, software only implementations, or implementations with a combination of software and hardware. In addition, the present application can use a form of a computer program product that is implemented on one or more computer-usable storage media (including but not limited to a magnetic disk storage, a CD-ROM, and an optical memory) that include computer-usable program code.

The present application is described with reference to the flowcharts and/or block diagrams of the method, the device (system), and the computer program product according to the implementations of the present application. It should be understood that computer program instructions can be used to implement each process and/or each block in the flowcharts and/or the block diagrams and a combination of a process and/or a block in the flowcharts and/or the block diagrams. These computer program instructions can be provided for a general-purpose computer, a dedicated computer, an embedded processor, or a processor of another programmable data processing device to generate a machine, so that the instructions executed by the computer or the processor of the another programmable data processing device generate an apparatus for implementing a specific function in one or more processes in the flowcharts and/or in one or more blocks in the block diagrams.

These computer program instructions can be stored in a computer readable memory that can instruct the computer or the another programmable data processing device to work in a specific method, so that the instructions stored in the computer readable memory generate an artifact that includes an instruction apparatus. The instruction apparatus implements a specific function in one or more processes in the flowcharts and/or in one or more blocks in the block diagrams.

These computer program instructions can be loaded onto the computer or the another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

In a typical configuration, a computing device includes one or more processors (CPU), an input/output interface, a network interface, and a memory.

The memory can include a non-persistent storage, a random access memory (RAM), a nonvolatile memory, and/or another form in a computer readable medium, for example, a read-only memory (ROM) or a flash memory. The memory is an example of the computer readable medium.

The computer readable medium includes persistent, non-persistent, movable, and unmovable media that can implement information storage by using any method or technology. Information can be a computer readable instruction, a data structure, a program module, or other data. A computer storage medium includes but is not limited to a phase-change random access memory (PRAM), a static random access memory (SRAM), a dynamic random access memory (DRAM), a random access memory (RAM) of another type, a read-only memory, an electrically erasable programmable read-only memory (EEPROM), a flash memory or another memory technology, a compact disc read-only memory (CD-ROM), a digital versatile disc (DVD), or another optical storage, a cassette, a cassette magnetic disk storage, or another magnetic storage device or any other non-transmission medium. The computer storage medium can be configured to store information that can be accessed by the computing device. Based on the definition in the present specification, the computer readable medium does not include transitory computer-readable media, for example, a modulated data signal and carrier.

It is worthwhile to further note that the term “include”, “contain”, or any other variant thereof is intended to cover a non-exclusive inclusion, so that a process, a method, an article, or a device that includes a list of elements not only includes those elements but also includes other elements which are not expressly listed, or further includes elements inherent to such a process, method, article, or device. An element preceded by “includes a . . . ” does not, without more constraints, preclude the existence of additional identical elements in the process, method, article, or device that includes the element.

A person skilled in the art should understand that the implementations of the present application can be provided as a method, a system, or a computer program product. Therefore, the present application can use a form of hardware only implementations, software only implementations, or implementations with a combination of software and hardware. In addition, the present application can use a form of a computer program product that is implemented on one or more computer-usable storage media (including but not limited to a magnetic disk storage, a CD-ROM, and an optical memory) that include computer-usable program code.

The previous descriptions are merely implementations of the present application, and are not intended to limit the present application. For a person skilled in the art, the present application can have various modifications and changes. Any modifications, equivalent substitutions, improvements, etc. made in the spirit and principle of the present application shall fall within the scope of the claims in the present application.

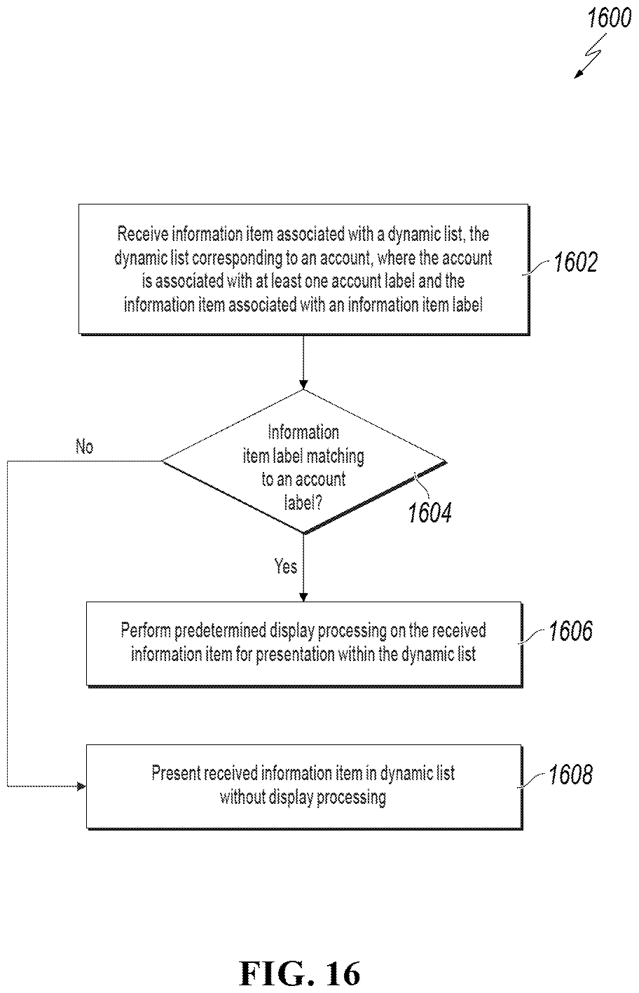

FIG. 16 is a flowchart illustrating an example of a computer-implemented method 1600 for displaying a dynamic list, according to an implementation of the present disclosure. For clarity of presentation, the description that follows generally describes method 1600 in the context of the other figures in this description. However, it will be understood that method 1600 can be performed, for example, by any system, environment, software, and hardware, or a combination of systems, environments, software, and hardware, as appropriate. In some implementations, various steps of method 1600 can be run in parallel, in combination, in loops, or in any order.

In general, FIG. 16 describes a solution for displaying information items in a dynamic list. In the described solution, relevant labels can be assigned to accounts, as well as to specific information items (for example, posts, submissions, stories, or updates) posted by one or more user accounts. When refreshing a dynamic list of information, such as a news feeds, information list, or other dynamic list, a client device can perform the operations described herein to provide and present information items in a way that items having a label matching an existing account label can be distinctly presented. In doing so, those information items of particular interest can be presented easily and clearly to the user without additional effort, and preferred content can be seen without additional effort by the user.

Turning to the illustrated implementation, at 1602, an information item associated with a dynamic list can be received, where the dynamic list corresponds to or is associated with a particular account. Each account may also be associated with one or more account labels. In some instances, the account label may be added by a server or backend system automatically. For example, the server or backend system can perform a statistical analysis on browsing behavior of a particular user associated with the account, and can determine one or more labels to be associated with the account. Alternately, other analyses can be performed by the server or backend system to determine what, if any, labels are to be applied to the particular account. One or more than one label may be associated with an account, and can be used to identify preferences of the user, topics relevant to the user, or other user and/or account descriptors. In some instances, labels may be manually selected by a user associated with the user account. For example, the user may select particular topics which are of interest to the user (for example, particular sports, professional organizations, topics, or people), and a label corresponding to those areas of interest can be associated with the account.

As described, users can log into the user account in an application program running on a client device or via an open webpage or web-based application. Users can follow other users or information sources, and may follow multiple accounts. Further, each user account may be followed or subscribed to by a plurality of other user accounts. When a user of one account posts or submits an information item, other user accounts who have followed or subscribed to that user account can receive, in their own dynamic list, the posted or submitted information item. At least some of the information items posted or submitted by user accounts can be identified or associated with a label. The labels applied to particular information items may be similar to those labels used to label the user accounts, and can be used from a shared or common label library. In some instances, a semantic analysis of text content in the information item may be performed to identify a particular label, while in other instances the user posting the information item may specifically identify a label. In some instances, a hashtag or other specific content may be used to determine a particular label to apply to the information content. Where the information content is an image or video, feature identification can be used to determine content of the image or video and obtain a label to be applied to the information item. In some instances, the server or backend system can analyze one or more attributes of the information item to determine the information item label to be applied. Once a label is applied to the information item posted by the user account, the server or backend system can push, or make available, the posted information item and the added label to those user accounts following the user account which posted the information. Thus, at 1602, the information item is received. From 1602, method 1600 proceeds to 1604.

At 1604, a determination is made as to whether an information item label of the received information item matches or corresponds to a particular account label associated with the user account receiving the information item. As mentioned, the account labels and the information item labels can be selected from a common or shared label library, such that common labels can be identified when content of an information item matches or corresponds to an interest area of the user account. If it is determined that the information item label of the received information item matches one of the account labels of the user account, then method 1600 proceeds to 1606. Otherwise, if it is determined that the information item label of the received information item does not match one of the account labels of the user account, method 1600 proceeds to 1608, where the received information item is presented in the dynamic list without adding any display processing. After 1608, method 1600 can stop.

At 1606, the client device can perform predetermined display processing on the received information item for presentation within the dynamic list. The predetermined display processing can take various forms and operations, and is not meant to be limiting. Example display processing is meant to provide an indication that the particular information item is associated with a particular account label associated with the account, and allows the user of the user account to easily see or be informed of the indication upon presentation of the received information item or during interactions with the dynamic list. Examples of the predetermined display processing will be described below. After 1606, method 1600 can stop.

Returning to the examples of the predetermined display processing, any number of possible solutions may be implemented. In some instances, the matching information item label of the received information item may be displayed in the dynamic list, such as adjacent to an identifier of the information item, or as an annotation to the presented information item. In some instances, the matching information item label may be presented upon an interaction with the particular information item, such as after a hover over or touch input to the particular information item. In some instances, the information item, and potentially other information items having the same matching information item label, may be presented in a different color and/or font, or may be highlighted within the dynamic list. In some instances, a combination of the options may be used to identify the particular matching label.

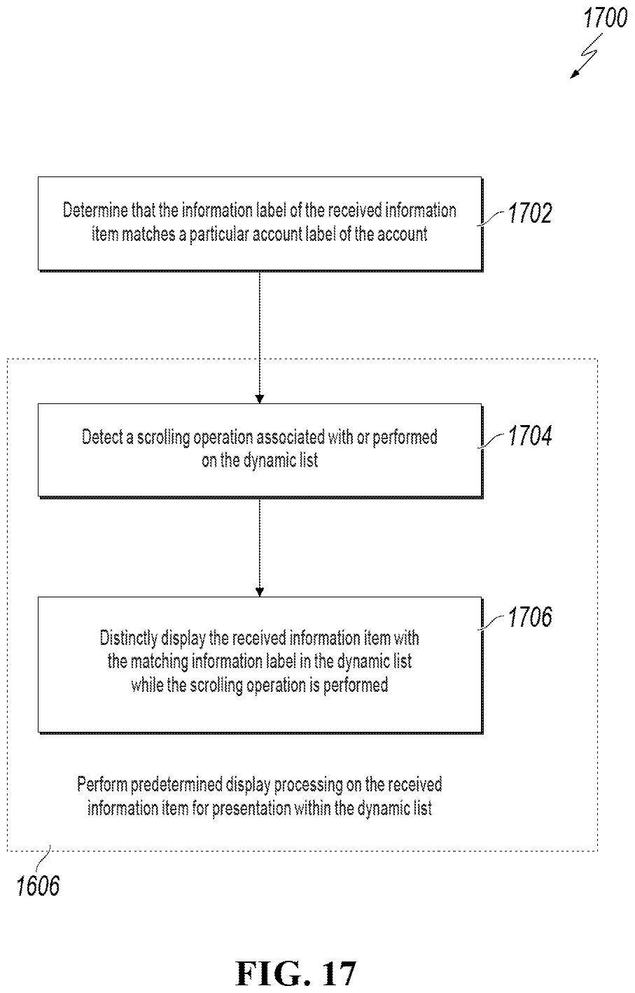

FIG. 17 is a flowchart illustrating an example of performing predetermined display processing on a received information item for presentation within a dynamic list, according to an implementation of the present disclosure. For clarity of presentation, the description that follows generally describes method 1700 in the context of the other figures in this description, and in particular, in some instances of method 1600. However, it will be understood that method 1700 can be performed, for example, by any system, environment, software, and hardware, or a combination of systems, environments, software, and hardware, as appropriate. In some implementations, various steps of method 1700 can be run in parallel, in combination, in loops, or in any order.

At 1702, a determination is made that the information label of the received information item matches a particular account label of the user account. Operation 1702 may be associated with the “YES” path after determination 1604 of method 1600. From 1702, method 1700 proceeds to 1704 (as illustrated within 1606 of FIG. 16).

At 1704, a scrolling operation associated with or performed on the dynamic list to which the information item has been added may be performed. The scrolling operation may be a continuous scrolling of the dynamic list by the user, or the scrolling operation may be a continuous dragging of the dynamic list on a screen of the client device. From 1704, method 1700 proceeds to 1706.

At 1706, in response to and while the scrolling operation is performed, the received information item can be distinctly displayed with the matching information item label in the dynamic list.

In some instances, distinctly displaying the received information with the matching information item label in the dynamic list can include modifying a relative display brightness of the dynamic list so that the relative brightness of the received information item, and, in some cases, any of the other information items in the dynamic list with labels matching the particular account label, is presented at a relatively higher brightness level than other information items that do not match the account label. In some instances, matching information items can be made brighter, while in other instances, non-matching information items can be made darker. In some of those instances, matching information items can be made brighter while non-matching information items can be made darker, or can be shaded.

In other instances, matching information items may be modified to a particular color signifying or associated with a particular information label.

In some instances, displaying the received information with the matching information item label in the dynamic list can include hierarchically displaying the received information item with the matching information item label so that the received information item is displayed in an upper portion of the dynamic list used to present information items matching the particular account label. In such instances, the dynamic list may include a first portion and a second portion, where the first portion is reserved for information items with labels that match the account labels of the user account. In some instances, the first portion may be an upper portion of the dynamic list when the list is presented from top to bottom. In some instances, the upper portion may include space, or may be expanded to include, a predetermined number of information items for presentation.

In some instances, hierarchically displaying the received information item can further include determining whether the upper portion of the dynamic list is filled with a number of information items matching the particular account label equal to the predetermined number of information items for which space is allowed when a new information item matching the account label is received. If space is available and the upper portion is not filled, then the new information item can be displayed within the upper portion of the dynamic list. If, however, the space is filled, then the information items can be controlled to scroll when the upper portion of the dynamic list is filled to an earliest information item that enters the dynamic list after the upper portion of the dynamic list is filled. After 1706, method 1700 can stop.

Embodiments and the operations described in this specification can be implemented in digital electronic circuitry, or in computer software, firmware, or hardware, including the structures disclosed in this specification or in combinations of one or more of them. The operations can be implemented as operations performed by a data processing apparatus on data stored on one or more computer-readable storage devices or received from other sources. A data processing apparatus, computer, or computing device may encompass apparatus, devices, and machines for processing data, including by way of example a programmable processor, a computer, a system on a chip, or multiple ones, or combinations, of the foregoing. The apparatus can include special purpose logic circuitry, for example, a central processing unit (CPU), a field programmable gate array (FPGA) or an application-specific integrated circuit (ASIC). The apparatus can also include code that creates an execution environment for the computer program in question, for example, code that constitutes processor firmware, a protocol stack, a database management system, an operating system (for example an operating system or a combination of operating systems), a cross-platform runtime environment, a virtual machine, or a combination of one or more of them. The apparatus and execution environment can realize various different computing model infrastructures, such as web services, distributed computing and grid computing infrastructures.

A computer program (also known, for example, as a program, software, software application, software module, software unit, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A program can be stored in a portion of a file that holds other programs or data (for example, one or more scripts stored in a markup language document), in a single file dedicated to the program in question, or in multiple coordinated files (for example, files that store one or more modules, sub-programs, or portions of code). A computer program can be executed on one computer or on multiple computers that are located at one site or distributed across multiple sites and interconnected by a communication network.

Processors for execution of a computer program include, by way of example, both general- and special-purpose microprocessors, and any one or more processors of any kind of digital computer. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data. A computer can be embedded in another device, for example, a mobile device, a personal digital assistant (PDA), a game console, a Global Positioning System (GPS) receiver, or a portable storage device. Devices suitable for storing computer program instructions and data include non-volatile memory, media and memory devices, including, by way of example, semiconductor memory devices, magnetic disks, and magneto-optical disks. The processor and the memory can be supplemented by, or incorporated in, special-purpose logic circuitry.

Mobile devices can include handsets, user equipment (UE), mobile telephones (for example, smartphones), tablets, wearable devices (for example, smart watches and smart eyeglasses), implanted devices within the human body (for example, biosensors, cochlear implants), or other types of mobile devices. The mobile devices can communicate wirelessly (for example, using radio frequency (RF) signals) to various communication networks (described below). The mobile devices can include sensors for determining characteristics of the mobile device's current environment. The sensors can include cameras, microphones, proximity sensors, GPS sensors, motion sensors, accelerometers, ambient light sensors, moisture sensors, gyroscopes, compasses, barometers, fingerprint sensors, facial recognition systems, RF sensors (for example, Wi-Fi and cellular radios), thermal sensors, or other types of sensors. For example, the cameras can include a forward- or rear-facing camera with movable or fixed lenses, a flash, an image sensor, and an image processor. The camera can be a megapixel camera capable of capturing details for facial and/or iris recognition. The camera along with a data processor and authentication information stored in memory or accessed remotely can form a facial recognition system. The facial recognition system or one-or-more sensors, for example, microphones, motion sensors, accelerometers, GPS sensors, or RF sensors, can be used for user authentication.

To provide for interaction with a user, embodiments can be implemented on a computer having a display device and an input device, for example, a liquid crystal display (LCD) or organic light-emitting diode (OLED)/virtual-reality (VR)/augmented-reality (AR) display for displaying information to the user and a touchscreen, keyboard, and a pointing device by which the user can provide input to the computer. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments can be implemented using computing devices interconnected by any form or medium of wireline or wireless digital data communication (or combination thereof), for example, a communication network. Examples of interconnected devices are a client and a server generally remote from each other that typically interact through a communication network. A client, for example, a mobile device, can carry out transactions itself, with a server, or through a server, for example, performing buy, sell, pay, give, send, or loan transactions, or authorizing the same. Such transactions may be in real time such that an action and a response are temporally proximate; for example an individual perceives the action and the response occurring substantially simultaneously, the time difference for a response following the individual's action is less than 1 millisecond (ms) or less than 1 second (s), or the response is without intentional delay taking into account processing limitations of the system.

Examples of communication networks include a local area network (LAN), a radio access network (RAN), a metropolitan area network (MAN), and a wide area network (WAN). The communication network can include all or a portion of the Internet, another communication network, or a combination of communication networks. Information can be transmitted on the communication network according to various protocols and standards, including Long Term Evolution (LTE), 5G, IEEE 802, Internet Protocol (IP), or other protocols or combinations of protocols. The communication network can transmit voice, video, biometric, or authentication data, or other information between the connected computing devices.

Features described as separate implementations may be implemented, in combination, in a single implementation, while features described as a single implementation may be implemented in multiple implementations, separately, or in any suitable sub-combination. Operations described and claimed in a particular order should not be understood as requiring that the particular order, nor that all illustrated operations must be performed (some operations can be optional). As appropriate, multitasking or parallel-processing (or a combination of multitasking and parallel-processing) can be performed.

What is claimed is:

1. A computer-implemented method, comprising:
receiving an information item associated with a dynamic list, the dynamic list corresponding to an account, wherein the account is associated with at least one account label, and wherein the received information item is associated with an information item label;
determining whether the information item label of the received information item matches a particular account label of the at least one account label; and
in response to determining that the information item label of the received information item matches a particular account label of the at least one account label, performing predetermined display processing on the received information item for presentation within the dynamic list on a client device.

2. The computer-implemented method of claim 1, wherein performing predetermined display processing on the received information item for presentation within the dynamic list comprises:
displaying the matching information item label of the received information item in the dynamic list.

3. The computer-implemented method of claim 1, wherein performing predetermined display processing on the received information item for presentation within the dynamic list comprises:
detecting a scrolling operation performed on the dynamic list; and
in response to detecting the scrolling operation, distinctly displaying the received information item with the matching information item label in the dynamic list while the detected scrolling operation is performed.

4. The computer-implemented method of claim 3, wherein the scrolling operation is one of a continuous scrolling of the dynamic list or a continuous dragging of the dynamic list on a screen of the client device.

5. The computer-implemented method of claim 3, wherein distinctly displaying the received information item with the matching information item label in the dynamic list comprises:
modifying a relative display brightness of the dynamic list so that the relative brightness of the received information item and any other information items matching the particular account label of the at least one account label are presented at a relatively higher brightness than other information items that do not match the particular one of the at least one account label.

6. The computer-implemented method of claim 3, wherein distinctly displaying the received information item with the matching information item label in the dynamic list comprises:
hierarchically displaying the received information item with the matching information item label so that the received information item is displayed in an upper portion of the dynamic list presenting information items matching the particular account label of the at least one account label, wherein the dynamic list comprises an upper portion and a lower portion.

7. The computer-implemented method of claim 6, wherein the upper portion of the dynamic list includes space for a predetermined number of information items to be presented.

8. The computer-implemented method of claim 7, wherein hierarchically displaying the received information item with the matching information item label comprises:
determining whether the upper portion of the dynamic list is filled with a number of information items matching the particular account label of the at least one account label equaling the predetermined number of information items when another information item matching the particular account label of the at least one account label is received;
in response to determining that the upper portion of the dynamic list is not filled, displaying the another information item in the upper portion of the dynamic list; and
in response to determining that the upper portion of the dynamic list is filled, controlling information items at the upper portion of the dynamic list to scroll when the upper portion of the dynamic list is filled to scroll an earliest information item that enters the dynamic list after the upper portion of the dynamic list.

9. The computer-implemented method of claim 1, wherein account labels are added automatically by a server to the account or manually by a user at a client device.

10. The computer-implemented method of claim 1, wherein receiving the information item associated with the dynamic list comprises obtaining an information item posted by a second account followed by a first account that logs in locally at the client device, and wherein the information item label of the received information item is added by a server to the received information item based on content or an attribute of the information item.

11. The computer-implemented method of claim 1, wherein performing predetermined display processing on the received information item for presentation within the dynamic list on the client device comprises displaying, as an annotation to the received information item in the dynamic list, that the information item that has the same information item label as the account.

12. A non-transitory, computer-readable medium storing one or more instructions executable by a computer system to perform operations comprising:
receiving an information item associated with a dynamic list, the dynamic list corresponding to an account, wherein the account is associated with at least one account label, and wherein the received information item is associated with an information item label;
determining whether the information item label of the received information item matches a particular account label of the at least one account label; and
in response to determining that the information item label of the received information item matches a particular account label of the at least one account label, performing predetermined display processing on the received information item for presentation within the dynamic list on a client device.

13. The computer-readable medium of claim 12, wherein performing predetermined display processing on the received information item for presentation within the dynamic list comprises:
displaying the matching information item label of the received information item in the dynamic list.

14. The computer-readable medium of claim 12, wherein performing predetermined display processing on the received information item for presentation within the dynamic list comprises:
detecting a scrolling operation performed on the dynamic list; and
in response to detecting the scrolling operation, distinctly displaying the received information item with the matching information item label in the dynamic list while the detected scrolling operation is performed.

15. The computer-readable medium of claim 14, wherein the scrolling operation is one of a continuous scrolling of the dynamic list or a continuous dragging of the dynamic list on a screen of the client device.

16. The computer-readable medium of claim 14, wherein distinctly displaying the received information item with the matching information item label in the dynamic list comprises:
modifying a relative display brightness of the dynamic list so that the relative brightness of the received information item and any other information items matching the particular account label of the at least one account label are presented at a relatively higher brightness than other information items that do not match the particular one of the at least one account label.

17. The computer-readable medium of claim 14, wherein distinctly displaying the received information item with the matching information item label in the dynamic list comprises:
hierarchically displaying the received information item with the matching information item label so that the received information item is displayed in an upper portion of the dynamic list presenting information items matching the particular account label of the at least one account label, wherein the dynamic list comprises an upper portion and a lower portion.

18. The computer-readable medium of claim 17, wherein the upper portion of the dynamic list includes space for a predetermined number of information items to be presented, and wherein hierarchically displaying the received information item with the matching information item label comprises:
determining whether the upper portion of the dynamic list is filled with a number of information items matching the particular account label of the at least one account label equaling the predetermined number of information items when another information item matching the particular account label of the at least one account label is received;
in response to determining that the upper portion of the dynamic list is not filled, displaying the another information item in the upper portion of the dynamic list; and
in response to determining that the upper portion of the dynamic list is filled, controlling information items at the upper portion of the dynamic list to scroll when the upper portion of the dynamic list is filled to scroll an earliest information item that enters the dynamic list after the upper portion of the dynamic list.

19. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
receiving an information item associated with a dynamic list, the dynamic list corresponding to an account, wherein the account is associated with at least one account label, and wherein the received information item is associated with an information item label;
determining whether the information item label of the received information item matches a particular account label of the at least one account label; and
in response to determining that the information item label of the received information item matches a particular account label of the at least one account label, performing predetermined display processing on the received information item for presentation within the dynamic list on a client device.

20. The computer-implemented system of claim 19, wherein performing predetermined display processing on the received information item for presentation within the dynamic list comprises:
detecting a scrolling operation performed on the dynamic list; and
in response to detecting the scrolling operation, distinctly displaying the received information item with the matching information item label in the dynamic list while the detected scrolling operation is performed.
